(19) United States
(12) Patent Application Publication
(10) Pub. No.: US 2024/0344865 A1
(43) Pub. Date: Oct. 17, 2024

(54) MEASURING THE FLOW RATE OF HYDROGEN IN A PIPE

(71) Applicant: Binder GmbH, Ulm (DE)

(72) Inventor: Robert Binder, Laichingen (DE)

(21) Appl. No.: 18/756,000

(22) Filed: Jun. 27, 2024

Related U.S. Application Data
(63) Continuation of application No. PCT/EP2022/084987, filed on Dec. 8, 2022.

(30) Foreign Application Priority Data
Jan. 14, 2022 (DE) 10 2022 100 779.0

(51) Int. Cl. G01F 1/684; G01F 15/04

(52) U.S. Cl. CPC G01F 1/6842; G01F 15/04

(57) ABSTRACT

A measurement device for measuring the flow rate of hydrogen flowing through a pipe, comprising: a pipe piece having first and second longitudinal end portions, a central longitudinal portion, and first and second longitudinal transition portions; a plurality of radially inwardly protruding baffle plates extending from the first longitudinal end portion into the central longitudinal portion; a flow conditioner element provided at an upstream end of the central longitudinal portion; a circular baffle element located at a downstream end of the central longitudinal portion so as to be concentric with the pipe piece and defining an annular gap through which a flow can pass; and a sensor element for measuring the flow rate at a measurement point which is positioned on the central longitudinal axis (L) of the pipe piece at a distance from the baffle element which corresponds to a second inner diameter (D2) of the central longitudinal portion.

### CROSS REFERENCES TO RELATED APPLICATIONS

This application is a continuation of co-pending international patent application PCT/EP2022/084987 filed on Dec. 8, 2022 and designating the U.S., which claims priority of German patent application DE 10 2022 100 779.0, filed on Jan. 14, 2022.

### FIELD

The present invention generally relates to a measuring device for measuring the flow rate of hydrogen in a pipe.

### BACKGROUND

Although there are already measuring devices for measuring the flow rate of hydrogen on the market, these do not work sufficiently well. This is, inter alia, because it is difficult to calibrate the measuring devices due to the material and physical properties of hydrogen. The use of non-critical media, for example helium or other substitute gases, is either expensive or the results have limited meaningful value.

In addition, calibration is also made more difficult by the fact that flow-related effects outside the measuring device, for example those caused by preceding or subsequent control valves, sharp bends in the pipes before or after the measuring device, etc., have a major effect on the measurement results and are extremely difficult to reproduce during calibration.

### SUMMARY

Against this background, an object of the present disclosure is to provide a measuring device for measuring the flow rate of hydrogen which is simple to calibrate and thus provides reliably reproducible measured values, irrespective of the installation conditions of the measuring device.

This object may be achieved by a measuring device for measuring the flow rate of hydrogen according to claim 1.

The measuring device may comprise a pipe piece having a first, upstream, longitudinal end portion and a second, downstream, longitudinal end portion, each having a first inner diameter D1 (connection nominal diameter) and being provided for connection to a pipe, a central longitudinal portion having a second inner diameter D2, wherein D2 is greater than D1, and in each case a longitudinal transition portion which has a varying inner diameter and is provided between a longitudinal end portion and the central longitudinal portion. Furthermore, a plurality of radially inwardly extending baffle plates are provided, which run from the first longitudinal end portion into the central longitudinal portion, a flow conditioner element, which is provided at the upstream end of the central longitudinal portion, and a circular baffle element, which is arranged at the downstream end of the central longitudinal portion so as to be concentric with the pipe piece and which defines an annular gap through which a flow can pass. Finally, a sensor element for measuring the flow rate at a measuring point is provided, wherein the measuring point is located on the central longitudinal axis of the pipe piece at a distance from the baffle element corresponding to the second inner diameter D2, i.e., in other words, the measuring point is located at what is known as the stagnation point before the baffle element.

An advantage of this measuring device is that the influent hydrogen gas is perfectly conditioned, so effects caused by preceding or subsequent elements in the pipe are intercepted effectively. In particular, intercepting external effects makes it possible to calibrate the measuring device effectively.

In this manner, the object is achieved in full.

In a preferred development, the flow conditioner element is formed as a perforated plate or slotted plate. A perforated plate of this type having a large number of through-openings may be provided simply and cost-effectively and also results in a very low pressure drop when used for hydrogen and in the central longitudinal portion with an expanded diameter D2. At this point it should be noted that the term “perforated plate” is used to mean both perforated plates and slotted plates. In other words, the geometry of the through-openings in the perforated plate may differ, i.e. the through-openings may be circular, slot-like, etc., and may preferably also be a combination thereof. In principle, the function of the perforated plate is to generate, for example by means of holes with different diameters and slots in the outer region, a flow with a flow profile of the greatest possible homogeneity in the following portion. The holes and slots, and the positions and free through-flow areas thereof, may be determined by means of CFD flow simulation using an approximation method. As a second priority, it is preferred that the free cross section is as large as possible, for example 40-50% of the area of the cross section of the central portion, which corresponds to approximately 70-80% of the area of the connection cross section.

In a preferred development, four deflector plates are provided, which are arranged at a uniform distance from one another in the circumferential direction of the pipe piece. The use of four deflector plates has been found to be particularly effective in homogenizing the tangential flow.

In a preferred development, the baffle element has a curved surface, in particular comparable to a flattened hemisphere, wherein the curve is oriented counter to the direction of flow. A component of this type may be provided cost-effectively and achieves effective flow conditioning, producing a reproducible, homogenized annular flow within the pipe piece. The baffle element has two functions in particular, i.e., to create a stagnation point for measurement on the one hand, and on the other to prevent any flow-related effects caused by subsequent components from acting on the measuring point.

In a preferred development, the two longitudinal end portions are each equipped with a flange for connection to a pipe. This measure has the advantage that the measuring device may be installed in an existing pipe system in a very simple manner.

In a preferred development, the deflector plates have a radially inner edge which extends at least partially parallel to the longitudinal axis of the pipe piece. This configuration has likewise been found to be advantageous.

In a preferred development, the measuring element is provided in the form of one or more measuring tips. The measuring tips are arranged in such a way that they are located at the measuring point.

As a result of the aforementioned conditioning of the flow, in particular the reduction of the flow velocity, the measurement results are not distorted, the measuring tip is not subject to excessive cooling, and in some measurement methods, for example mass flow measurements using the thermal method, the measuring span is advantageously increased.

In a preferred development, the inner diameters D2 and D1 are selected in such a way that they are in a ratio of from 1.17 to 1.3 (D2/D1=1.17 to 1.3), preferably approximately 1.25. If the inner diameter D1 is for example approximately 80 mm, then the second inner diameter D2 is in the region of approximately 100 mm.

In a preferred development, the baffle element is formed as a torispherical head in accordance with German standard DIN 28011. This measure has the advantage that the baffle element can be provided cost effectively, since it is a standard component. At this point, however, it should be noted that there are also other torispherical heads which deviate from this DIN standard and may likewise be used.

In a preferred development, the length of the pipe piece is seven to twelve times the first inner diameter D1. It is further preferred that the flow conditioner element, as viewed in the direction of flow, is arranged at a distance of 0.5 times D2 from the end of the central longitudinal portion.

In a preferred development, a plurality of, preferably four, plates or tabs which project inward obliquely in the direction of flow are provided in the first longitudinal end portion. This measure has the advantage that the flow can be further conditioned to calm a swirling flow.

In a preferred development, the flow conditioner element has a quantity of approximately 30 to 85 openings, wherein the quantity of openings depends, inter alia, on the connection nominal diameter used. It is further preferred that the flow conditioner element has both circular and slot-like openings, wherein the circular openings have diameters of from approximately 5 mm to 10 mm, preferably of from 5 mm to 8 mm.

In a preferred development, the ratio of the total area of the openings in the flow conditioner element to the total area of the cross section of the central longitudinal portion is between 40% and 50%.

The aforementioned features have been found to be particularly advantageous with regard to flow straightening.

An object of the present disclosure is also achieved by using a previously described measuring device in a pipe for measuring the flow rate of hydrogen.

It is understood that the features mentioned above and those to be explained below may be used not only in the combination specified in each case, but also in other combinations or alone, without departing from the scope of the present invention.

### DESCRIPTION OF THE DRAWINGS

Further advantages and configurations are set out in the description and the appended drawings, in which:

FIG. 1a shows a side view of the measuring device in a longitudinal section;

FIGS. 1b and 1c show a front and rear view of the measuring device from FIG. 1a;

FIGS. 2a and 2b show two sectional views of the measuring device from FIG. 1a;

FIG. 2c shows a view of a perforated plate; and

FIG. 3 is a side view of the measuring device from FIG. 1a for clarification of the dimensions.

### DESCRIPTION OF PREFERRED EMBODIMENTS

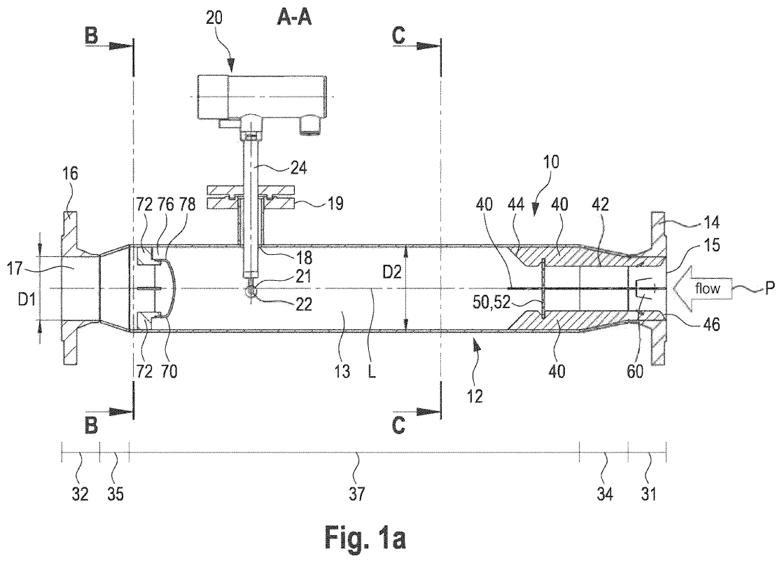

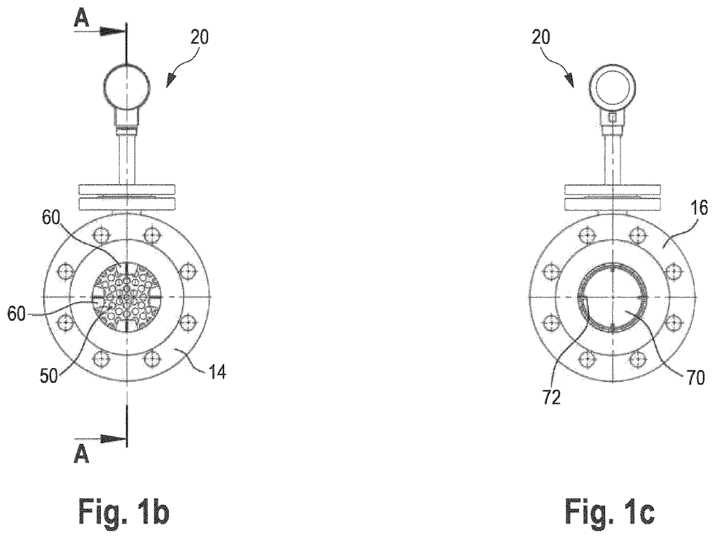

FIG. 1 shows a measuring device for measuring the flow rate of hydrogen in a longitudinal section, the device being denoted by the reference sign 10. The measuring device 10 comprises a pipe piece 12, which is configured to be insertable into a pipe (not shown). For this purpose, the measuring device 10 or the pipe piece 12 has a flange 14, 16 at each of the two ends thereof, enabling it to be connected at each end to an adjacent pipe.

Since it may be necessary to insert the measuring device 10 into the pipe in a direction- or flow-dependent manner, the terms “upstream” and “downstream” are used in the following, wherein the flange 14 is located at the upstream end and the flange 16 is located at the downstream end of the pipe piece 12, i.e., in other words, the gas to be measured, for example hydrogen in this case, flows into the pipe piece 12 in the region of the flange 14 and flows out of the pipe piece 12 in the region of the flange 16, as denoted by the arrow P.

To measure the flow rate, the measuring device 10 comprises a measuring apparatus 20, the construction and arrangement of which will be explained in detail below.

The pipe piece 12 is an elongate structural element having a cavity or interior 13, which is divided into various longitudinal portions. These various longitudinal portions are denoted by the reference signs 31, 32, 34, 35 and 37 in FIG. 1a.

The portion 31 is an end portion 31 of the pipe piece 12, this end portion being arranged at the upstream end. As shown in FIG. 1a, the flange 14 is provided in this end portion 31.

At the opposing end of the pipe piece 12, the portion 32 also forms an end portion 32, which is thus located at the downstream end and in which the flange 16 is provided.

The end portion 31 and the end portion 32 have an inlet or outlet opening 15 and 17 respectively, the opening diameters of which are identical. In the following, this diameter is denoted by D1.

The end portion 31 is adjoined, as viewed in the direction of flow, by a transition portion 34, the inner diameter of which increases from the diameter D1 to a larger inner diameter D2. As shown in FIG. 1a, this increase from D1 to D2 is preferably linear.

This transition portion 34 is adjoined, as viewed in the direction of flow, by the central portion 37, which comprises the measurement path for the flow rate measurement.

The inner diameter of the central portion 37 is constant over the entire length and corresponds to the value D2.

In order to reduce the inner diameter D2 to the inner diameter D1 of the outlet opening 17, the transition portion 35 is provided between the central portion 37 and the end portion 32. As viewed in the direction of flow, the transition portion 35 initially has an inner diameter D2, which then decreases in a preferably linear manner to the value D1.

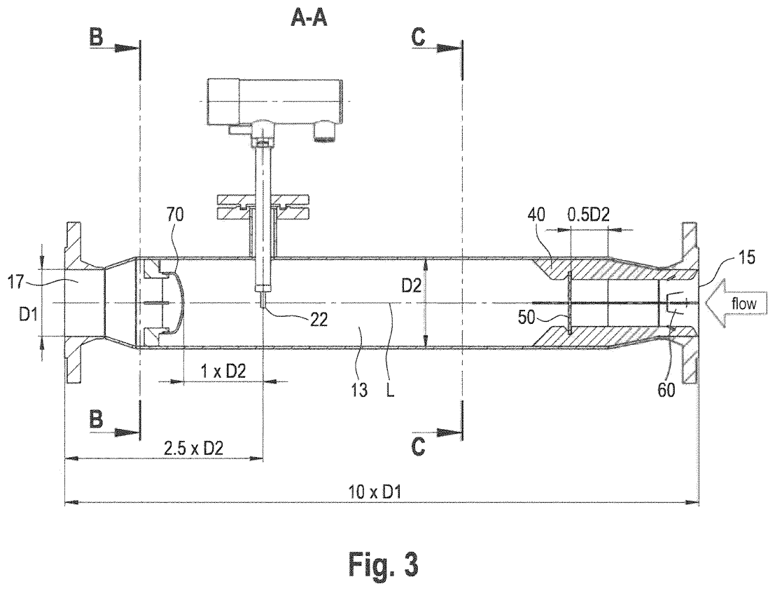

As shown in FIG. 1a, the aforementioned longitudinal portions 31, 34, 37, 35 and 32 extend concentrically about a common longitudinal axis L. The longitudinal extent of the central portion 37 is many times greater than the respective longitudinal extent of the other longitudinal portions. The relative proportions will be explained in detail below with reference to FIG. 3.

The pipe piece 12 comprises various elements which act to condition the flow in order to achieve effective, and in particular reproducible, measurement of the flow rate. Without these various elements within the pipe piece 12, the flow conditions within the pipe piece would change significantly depending on the geometry of the pipes before and after the pipe piece 12.

Provided at the upstream end of the pipe piece 12 is a plurality of, preferably four, deflector plates 40, which are arranged at a uniform distance in the circumferential direction of the pipe piece. The deflector plates 40 extend radially inward from the inner wall of the pipe piece 12, wherein a radially inner edge 42 runs substantially parallel to the longitudinal axis L. Only the edges 44 and 46 at the two longitudinal ends of the deflector plates 40 run obliquely to the longitudinal axis L.

As shown in FIG. 1a, the deflector plate 40 extends downstream from the inlet opening 15, through the end portion 31 and the transition portion 34, and terminates in a region of the central portion 37. As viewed in the direction of flow, this region is located approximately in the first third of the central portion 37.

The function of the plurality of deflector plates 40 is, in particular, to reduce what are known as swirling flows of influent hydrogen. Swirling flows of this type may be caused by elbows, etc., upstream of the pipe piece 12.

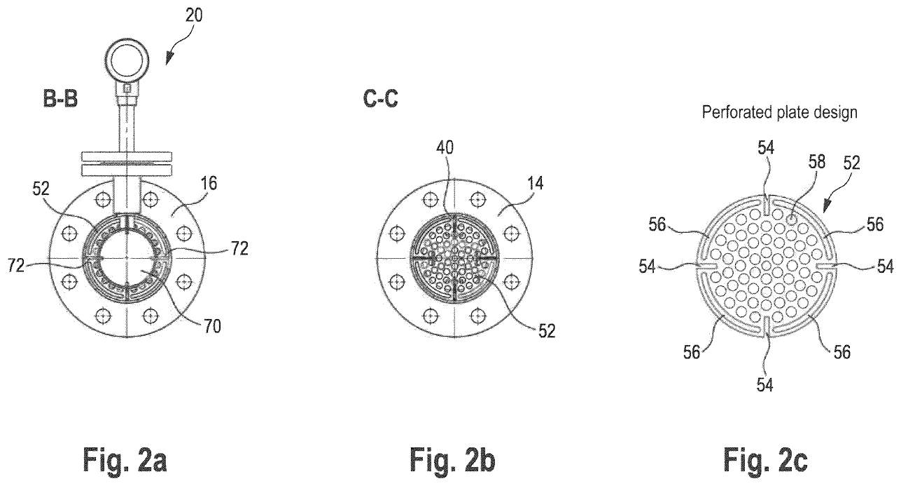

To further homogenize the flow, a flow conditioner 50 is provided in the region of the deflector plates 40 in the central portion 37. Preferably, the flow conditioner 50 is configured as a perforated plate 52. FIG. 2c shows a perforated plate 52 of this type in detail.

The perforated plate 52 takes the form of a circle, the diameter of which is smaller than the inner diameter D2 of the central portion 37. The perforated plate 52 has a plurality of radial notches 54, which are formed in such a way that one deflector plate 40 can engage in each notch. In this manner, the perforated plate 52 can be fastened to the deflector plates 40. Consequently, the quantity of notches 54 corresponds to the quantity of deflector plates 40 provided, and the diameter of the perforated plate is greater than the diameter of a notional circle along the inner edges 42 of the deflector plates 40.

Through-openings 56 are provided in an outer circular ring of the perforated plate 52, each through-opening extending along a circle segment between adjacent notches 54.

A large number of preferably circular through-openings 58 are provided in an inner region of the perforated plate 52, this inner region being delimited by the through-openings 56. A quantity of from 30 to 85 through-openings has been found to be particularly advantageous. The diameters of the circular through-openings fall within a range of from 5 mm to 10 mm, preferably 5 mm to 8 mm. Particularly preferably, the ratio of the total area of the through-openings to the total area of the central portion is between 40% and 50%, which corresponds to approximately 70-80% of the cross-sectional area of the end portion.

A further element for conditioning the flow is provided in the end portion 31. This is formed by a plurality of, in particular four, plates 60, which are connected to the inner wall of the end portion 31 at a uniform distance in the circumferential direction. The plates 60 are provided as trapezoidal plates which project inward obliquely to the longitudinal axis L, wherein they are inclined in the direction of flow, i.e., in other words, the plates 60 deflect the impinging flow in the direction of flow and toward the longitudinal axis. As shown in FIG. 1a, four plates 60 are provided in the present case. The latter are formed in such a way that they are fitted onto or connected to the deflector plates 40. At this point, however, it should be noted that the plates 60 are optionally provided, i.e., they are not a required element of the configuration according to the invention.

A further element for conditioning the flow is provided at the other end of the central portion 37 in the form of a baffle element 70. The baffle element 70 is formed so as to be circular and is held in a concentric manner relative to the longitudinal axis L on the inner wall of the central portion 37 by a plurality of, preferably four, retaining elements 72. The diameter of the baffle element 70 is smaller than the inner diameter D2, with the result that an annular gap 76 is defined between the retaining element 70 and the inner wall of the central portion 37. As shown in FIG. 1a, the baffle element 70 is positioned directly before the transition portion 35. The baffle element 70 is preferably two nominal diameters smaller than the diameter of the measurement path, i.e. the inner diameter D2 of the central longitudinal portion 37. The ratio of the diameter of the baffle element to the inner diameter D2 of the central longitudinal portion 37 preferably falls within a range of from 45% to 60%.

The baffle element 70 is preferably formed so as to be hemispherical or dome-shaped with an angled edge region 78, which is approximately parallel to the longitudinal axis L. The baffle element 70 is also arranged in such a way that the curve is directed upstream, and so the center of the circular baffle element represents the point which is furthest upstream, as viewed in the longitudinal direction. The baffle element 70 could preferably also be formed as what is known as a torispherical head, preferably in accordance with German standard DIN 28011.

The function of the baffle element 70 is to build up backpressure and thus to generate a flow profile of the highest possible stability and force the flow into the annular gap 76. The upstream region within the inner portion 37 is thus flow-conditioned, so it is possible to measure the flow rate in an advantageous manner within this region.

As is further shown in FIG. 1a, at least one measuring tip 22 of the measuring apparatus 20 is located precisely in this flow-conditioned region at a defined measuring point 21 (stagnation point). In particular, the measuring tip 22 is located in the region of the longitudinal axis L, i.e., centrally (as viewed in the radial direction) in the central portion 37. The exact distance from the measuring tip 22, i.e., the measuring point 21, to the baffle element 70 will be described in greater detail below.

At this point it should be noted that, in the present exemplary embodiment, a measuring device having one or more measuring tips is used to measure the flow rate. It is understood, however, that other measuring methods which do not require measuring tips of this type may also be used, provided that the measurement is taken at the defined measuring point 21. By way of example, possible methods include thermal methods or even ultrasound-based methods.

The measuring apparatus 20 has a tubular element 24, which projects into the interior 13 through an opening in the wall of the pipe piece 12. The measuring tip 22 then projects from the end of the tubular element 24. It is understood that a sealing apparatus 19 is provided at the opening, which is denoted by the reference sign 18. This sealing apparatus 19 ensures that hydrogen cannot escape from the interior 13 to the exterior through the opening 18, but it is still possible to replace the measuring tip. As already indicated above, the measuring apparatus 20 acts to measure the flow rate of hydrogen flowing through the pipe piece 12. Since flow rate measuring apparatuses of this type are known in principle, the mode of operation thereof will not be discussed further at this point.

It should also be noted in connection with the measuring apparatus 20 that the enlargement of the inner diameter from D1 to D2 causes a reduction in the flow velocity in order to ensure that the flow velocity, with the accompanying cooling of the measuring tip 22, does not exceed the maximum threshold in thermal measuring methods. This measure consequently also has a positive effect on the measurement result and the measurement range.

FIGS. 1b and 1c show a plan view of the two ends of the pipe piece 12. For simplification, the same reference numerals are used in the two figures to denote the same parts as in FIG. 1a. FIG. 1b clearly shows the plates 60, which extend radially inward toward the longitudinal axis L. The radial extent is in this case no greater than ⅓ of the radius of the inlet opening 15.

FIGS. 2a and 2b again show the pipe piece 12 in two different sectional views along the lines B-B and C-C of intersection respectively. The same reference signs as those in FIG. 1a are again used in this case.

The dimensions of the pipe piece 12 and the positions of various elements within the pipe piece 12 are discussed in the following with reference to FIG. 3.

As already mentioned, the diameter of both the outlet opening 17 and the inlet opening 15 has a value D1. This diameter D1 depends on what is known as the nominal diameter of the pipes (generally referred to as DN) to which the pipe piece 12 is to be connected. A nominal diameter of DN 80 is cited here as an example. In the case of a nominal diameter of DN 80, the inner diameter is approximately 80 mm. The inner diameter D2 therefore has a nominal diameter of DN 100, i.e., approximately 100 mm, in this case.

The total length of the pipe piece 12 is from seven to twelve times, preferably ten times, the inner diameter D1. The distance between the center of the baffle element 70 and the measuring tip 22 or the measuring point 21 in general is or corresponds preferably to D2, and the distance from the measuring tip 22/measuring point 21 to the outlet end 17 of the pipe piece 12 is approximately 2.5 times D2.

FIG. 3 also shows that the flow conditioner 50 is preferably arranged 0.5 times D2 away from the beginning of the central portion 37. Finally, it should also be noted that the deflector plate 40 extends radially inward in the central portion 37 by approximately ¼ times D2. These dimensions and positions of the elements relative to one another have been found to be particularly advantageous.

In operation, when the pipe piece 12 is installed in a pipe, the hydrogen gas flows in accordance with the arrow P through the opening 15 into the pipe piece 12 and is then conditioned directly by the deflector plates 40, optionally also by the plates 60, and the flow conditioner 50. Due to the low density and viscosity of hydrogen, the pressure drop at the flow conditioner 50 is merely a few millibars, which is readily acceptable in practice. However, the use of other gases would have very different results, and so the present measuring device 10 is formed and may be used in particular for measuring the flow rate of hydrogen.

Due to the enlargement of the inner diameter, the flow velocity is reduced and the flow itself is calmed, wherein the downstream baffle element 70 also serves this purpose. Located at the stagnation point of the baffle element 70 is the measuring point 21 or measuring tip 22, which can then measure the flow rate. The flow through the annular gap and the baffle element itself also have the advantage that downstream, i.e., subsequent, elements or control valves do not affect the measuring process. The rearward effect of a subsequent control valve of this type is intercepted, as it were, by the baffle element and annular gap.

The fact that the measuring device 10 is independent of preceding and subsequent elements in the pipes has the major advantage that the measuring device may be calibrated very precisely on a test bench without having to take into account the flow conditions outside the pipe piece 12. These effects are largely intercepted by the elements described.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A measuring device for measuring the flow rate of hydrogen flowing through a pipe, comprising:
a pipe piece which has:
a first upstream, longitudinal end portion and a second downstream, longitudinal end portion, each having a first inner diameter D1 (connection nominal diameter) and being provided for connection to a pipe;
a central longitudinal portion having a second inner diameter D2, wherein D2 is greater than D1; and
a first longitudinal transition portion and a second longitudinal transition portion, each having a varying inner diameter and being provided between a longitudinal end portion and the central longitudinal portion;
a plurality of radially inwardly extending deflector plates which run from the first longitudinal end portion to the central longitudinal portion;
a flow conditioner element provided at an upstream end of the central longitudinal portion;
a circular baffle element which is arranged at a downstream end of the central longitudinal portion so as to be concentric with the pipe piece and defines an annular gap through which a flow can pass; and
a sensor element for measuring the flow rate at a measuring point, wherein the measuring point is located on the central longitudinal axis (L) of the pipe piece at a distance, corresponding to the second inner diameter D2, from the baffle element.

2. The measuring device as claimed in claim 1, wherein the flow conditioner element is formed as a perforated plate.

3. The measuring device as claimed in claim 1, wherein four deflector plates are provided, which are arranged at a uniform distance from one another in a circumferential direction of the pipe piece.

4. The measuring device as claimed in claim 1, wherein the baffle element has a curved surface comparable to a flattened hemisphere, wherein the curve is oriented counter to a direction of flow.

5. The measuring device as claimed in claim 1, wherein the first and second longitudinal end portions are each equipped with a flange for connection to a pipe.

6. The measuring device as claimed in claim 1, wherein the deflector plates have a radially inner edge which extends at least partially parallel to the longitudinal axis (L) of the pipe piece.

7. The measuring device as claimed in claim 1, wherein the pipe piece has, in a pipe wall thereof, an opening, through which a sensor tip may be inserted as the sensor element.

8. The measuring device as claimed in claim 1, wherein the ratio of D2 to D1 is in a range from 1.17 to 1.3.

9. The measuring device as claimed in claim 1, wherein the flow conditioner element has from 30 to 85 openings.

10. The measuring device as claimed in claim 9, wherein the flow conditioner element has both circular and slot-like openings, the circular openings have diameters from 5 mm to 8 mm.

11. The measuring device as claimed in claim 9, wherein a ratio of a total area of the openings in the flow conditioner element to a total area of a cross section of the central longitudinal portion is between 40% and 50%.

12. The measuring device as claimed in claim 1, wherein the baffle element is formed as a torispherical head, in accordance with German standard DIN 28011.

13. The measuring device as claimed in claim 12, wherein a ratio of a diameter of the baffle element to the second inner diameter D2 of the central longitudinal portion is in a range from 45% to 60%.

14. The measuring device as claimed in claim 1, wherein the baffle element is connected to the pipe piece by a plurality of radially arranged support plates.

15. The measuring device as claimed in claim 1, wherein a length of the pipe piece is seven to twelve times the first inner diameter D1.

16. The measuring device as claimed in claim 1, wherein the flow conditioner element, as viewed in a direction of flow, is arranged at a distance of 0.5*D2 from a beginning of the central longitudinal portion.

17. The measuring device as claimed in claim 1, wherein a plurality of plates, which project inward obliquely in a direction of flow, are provided in the first longitudinal end portion.

18. A method of using the measuring device according to claim 1, wherein the method measures the flow rate of hydrogen flowing through a pipe.
